(19) United States
(12) Patent Application Publication
(10) Pub. No.: US 2006/0276618 A1
(43) Pub. Date: Dec. 7, 2006

(54) Activated forms of water-soluble polymers

(76) Inventors: Shawn DeFrees, North Wales, PA (US); David A. Zopf, Wayne, PA (US); Caryn Bowe, Doylestown, PA (US)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 10/549,520

(22) PCT Filed: Mar. 18, 2004
(86) PCT No.: PCT/US04/08593

§ 371 Date: Jul. 10, 2006

Related U.S. Application Data
(60) Provisional application No. 60/456,148, filed on Mar. 18, 2003.

(51) Int. Cl. C08G 65/34

(52) U.S. Cl. 528/425

(57) ABSTRACT

The present invention provides compositions of activated water-soluble polymers for preparing water-soluble polymer-modified peptides. Exemplary compounds of the invention include water-soluble polymers covalently attached to activated leaving groups wherein the water-soluble polymer is a member selected from PEG, PPG, PEG derivatives, and PPG derivatives, and the activated leaving group is a member selected from (formula I).

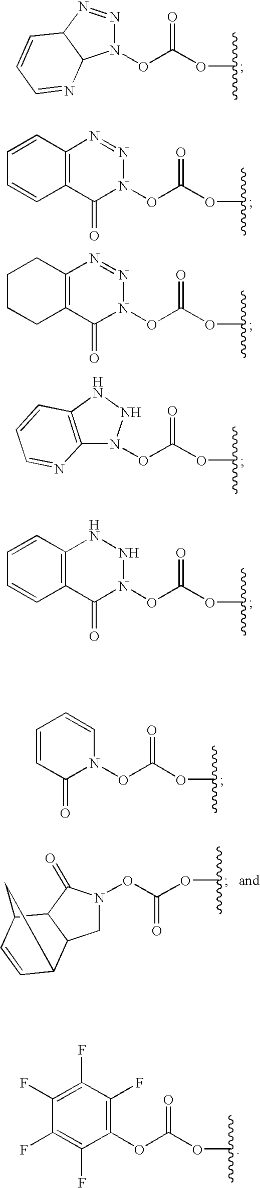

### BACKGROUND OF THE INVENTION

The administration of glycosylated and non-glycosylated peptides for engendering a particular physiological response is well known in the medicinal arts. A principal factor which has limited the use of therapeutic peptides is the immunogenic nature of most peptides. To provide soluble peptide therapeutics, water-soluble polymers have been attached to the peptide backbone.

Poly(ethylene glycol) (“PEG”) is an exemplary water-soluble polymer that has been conjugated to peptides. The use of PEG to derivatize peptide therapeutics has been demonstrated to reduce the immunogenicity of the peptides.

Currently, PEG, and its derivatives, are attached in a random, non-specific manner to reactive residues on a peptide backbone. For the production of therapeutic peptides, it is clearly desirable to utilize a derivatization strategy that results in the formation of a specifically labeled, readily characterizable, essentially homogeneous product. A promising route to preparing specifically labeled peptides is through the use of enzymes, such as glycosyltransferases, to append a water-soluble polymer modified sugar moiety onto a peptide.

In order to create the modified sugar moieties envisioned, activated forms of water-soluble polymers, such as PEG, are needed. The present invention fulfills these and other needs.

### BRIEF SUMMARY OF THE INVENTION

In response to the need for improved methods of preparing water-soluble polymer-modified peptides, the present invention provides compositions of activated water-soluble polymers.

In one aspect, the present invention provides an activated water-soluble polymer, comprising a water-soluble polymer covalently attached to an activated leaving group wherein the water-soluble polymer is a member selected from PEG, PPG, PEG derivatives, and PPG derivatives, and the activated leaving group is a member selected from

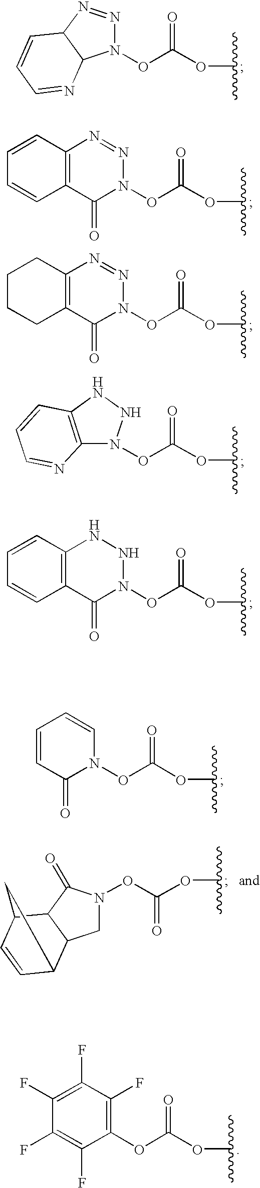

### DETAILED DESCRIPTION OF THE INVENTION

Abbreviations

The abbreviations used herein have their conventional meaning within the chemical and biological arts. For example, PEG stands for poly(ethyleneglycol), and PPG stands for poly(propyleneglycol).

### DEFINITIONS

Unless defined otherwise, all technical and scientific terms used herein generally have the same meaning as commonly understood by one of ordinary skill in the art to which this invention belongs. Generally, the nomenclature used herein and the laboratory procedures in organic chemistry are well known and commonly employed in the art. Standard techniques, or modifications thereof, are used for chemical syntheses and chemical analyses.

The term “polymer” refers to any of numerous natural and synthetic compounds of usually high molecular weight consisting of repeated linked units, each a relatively light and simple molecule.

The term “activated leaving group” refers to those moieties which are readily displaced in nucleophilic substitution reactions.

The symbol a [symbol] , whether utilized as a bond or displayed perpendicular to a bond indicates the point at which the displayed moiety is attached to the remainder of the molecule.

Introduction

Activated water-soluble polymer derivatives are created through the reaction of a water-soluble polymer with an activated leaving group.

a) Water-Soluble Polymers

The hydrophilicity of a selected peptide is enhanced by conjugation with polar molecules such as amine-, ester-, ether-, hydroxyl- and polyhydroxyl-containing molecules. Representative examples include, but are not limited to, polylysine, polyethyleneimine, poly(ethyleneglycol) and poly(propyleneglycol).

The present invention is further illustrated by reference to a poly(ethylene glycol) derivative. Several reviews and monographs on the functionalization and conjugation of PEG are available. See, for example, Harris, Macromol. Chem. Phys. C25: 325-373 (1985); Scouten, Methods in Enzymology 135: 30-65 (1987); Wong et al., Enzyme Microb. Technol. 14: 866-874 (1992); Delgado et al., Critical Reviews in Therapeutic Drug Carrier Systems 9: 249-304 (1992); Zalipsky, Bioconjugate Chem. 6: 150-165 (1995); and Bhadra et al., Pharmazie, 57:5-29 (2002).

The poly(ethylene glycol) useful in forming the compositions of the invention is either linear or branched. Examples of branched polymers, which are incorporated herein by reference, can be found in the catalog of Shearwater Polymers, Inc., Huntsville, Ala., as well as in U.S. Pat. Nos. 6,437,025, 6,436,386, and 6,362,254.

Exemplary PEG and PPG derivatives disclosed herein include, but are not limited to, PEG derivatives (e.g., alkyl-PEG, acyl-PEG, acyl-alkyl-PEG, alkyl-acyl-PEG carbamoyl-PEG, aryl-PEG), and PPG derivatives (e.g., acyl-PPG, acyl-alkyl-PPG, alkyl-acyl-PPG carbamoyl-PPG, aryl-PPG). In a preferred embodiment, the hydroxyl group at one end of a linear PEG molecule, or at one end of the main chain of a branched PEG molecule, is covalently attached to a methyl group.

b) Activated Leaving Groups

Preferred activated leaving groups, for use in the present invention, are those that do not significantly encumber the transfer of the sugar moiety to the water-soluble polymer. Accordingly, preferred embodiments include:

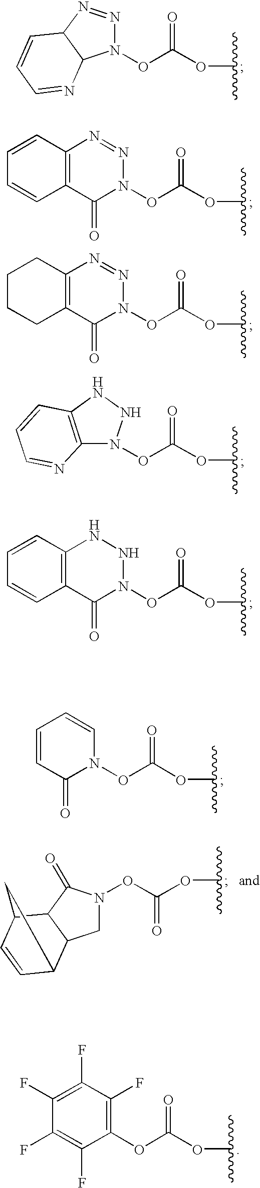

### EXAMPLES

The materials, methods and devices of the present invention are further illustrated by the example that follows. The example is offered to illustrate, but not to limit the claimed invention.

### Example 1

### Preparation of HOAt-PEG-OMe

Synthesis of HOAt-mPEG. In a 250 mL round-bottomed flask, 10 g (10 mmols of hydroxyl groups) of PEG-methyl ether (Aldrich, St. Louis, Mo.) was dissolved in 120 mL of toluene and the polymer solution was azeotropically dried for two hours under reflux using a Dean-Stark trap. The polymer solution was then cooled to 25° C. and 15 mL (29 mmol) of a 20 percent solution of phosgene in toluene (1.93 M) was added. The reaction mixture was stirred at 25° C. overnight and then evaporated to dryness on a rotary evaporator (water bath temperature maintained at 40° C.). Another 100 mL of toluene was added and evaporated to remove all traces of phosgene. To the polymeric chloroformate was added 30 mL of dry toluene, 10 mL of methylene chloride, and 1.7 g (14.8 mmol) of 1-hydroxy-7-azabenzotriazole (HOAt) (Aldrich, St. Louis, Mo.), and the mixture was stirred vigorously. The reaction flask was then cooled in an ice water bath and 1.5 g (14.9 mmol) of triethylamine was added gradually. Immediate precipitation of triethylamine hydrochloride was seen. The cooling bath was removed and the stirring continued at 25° C. for five hours. Then 10 mL of toluene was added and the reaction mixture cooled to 4° C. to maximize the triethylamine hydrochloride precipitation.

The precipitate was filtered and the filtrate concentrated to about half of its original volume. The concentrated solution was then added to 60 mL of ether with stirring to precipitate the polymeric product. After cooling to 40° C., the crude product was recovered by filtration, dried, redissolved in 100 mL of 2-propanol at 45° C. and allowed to recrystallize. The product was recovered by filtration, washed with ether and dried under high vacuum. A white crystalline solid was recovered.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. An activated water-soluble polymer, comprising a water-soluble polymer covalently attached to an activated leaving group wherein the water-soluible polymer is a member selected from PEG, PPG, PEG derivatives, and PPG derivatives, and the activated leaving group is a member selected from:

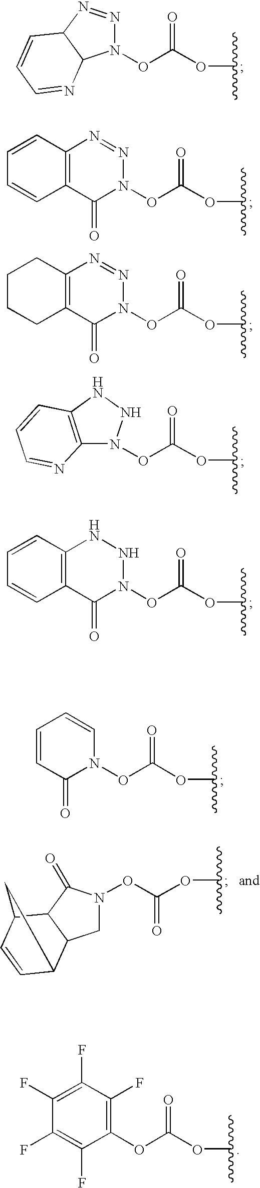

2. The activated water-soluble polymer of claim 1, wherein the water-soluble polymer is PEG-OCH₃.
